(19) United States
(12) Patent Application Publication
(10) Pub. No.: US 2013/0331168 A1
(43) Pub. Date: Dec. 12, 2013

(54) Gaming System and a Method of Gaming

(71) Applicant: Aristocrat Technologies Australia Pty Limited, North Ryde (AU)

(72) Inventor: Neil Edward Street, West Ryde (AU)

(21) Appl. No.: 13/912,269

(22) Filed: Jun. 7, 2013

(30) Foreign Application Priority Data
Jun. 7, 2012 (AU) 2012902394

(51) Int. Cl. G07F 17/34

(52) U.S. Cl. CPC G07F 17/34
USPC 463/20

(57) ABSTRACT

A gaming system having a game play mechanism in which an outcome evaluator evaluates a game outcome based on the wager made by the player. A plurality of symbols are selected for display, and determined whether the selected symbols correspond to a winning outcome. When a winning outcome is determined to exist, the outcome is communicated to the player by a symbol associated with the winning outcome being repeatedly and successively displayed and at least one modified representation of the symbol.

### RELATED APPLICATIONS

This application claims priority to Australian Provisional Patent Application No. 2012902394 having an International filing date of Jun. 7, 2012, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

It is known to provide a gaming system which comprises a game controller arranged to randomly display several symbols from a predetermined set of symbols and to determine a game outcome such as a winning symbol combination based on the displayed symbols. Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### BRIEF SUMMARY OF THE INVENTION

In accordance with a first aspect of the present invention, there is provided a gaming system comprising:
a display;
a symbol selector arranged to select a plurality of symbols for display; and
an outcome evaluator arranged to evaluate the selected symbols to determine whether a winning outcome exists;
the gaming system being arranged to communicate a winning outcome to a player by repeatedly successively displaying a symbol associated with the winning outcome and at least one modified representation of the symbol.

In one embodiment, the gaming system is arranged to communicate a winning outcome to a player by repeatedly successively displaying a symbol associated with the winning outcome and one modified representation of the symbol.

In one embodiment, the gaming system is arranged to communicate a winning outcome to a player by repeatedly successively displaying a symbol associated with the winning outcome and a plurality of modified representations of the symbol.

In one embodiment, the winning outcome is communicated to the player by repeatedly successively displaying all symbols associated with the winning outcome and at least one respective modified representation of each symbol.

In one embodiment, the modified representation of a symbol is a representation of the symbol wherein the colour of the symbol and/or the colour of a background of the symbol are modified.

In one embodiment, the modified representation of the symbol is an inverse representation of the symbol.

In one embodiment, the modified representation of the symbol is an outline representation of the symbol.

In one embodiment a winning outcome exists when a defined symbol combination coincides with a defined win line.

In another embodiment, a winning outcome exists when a defined symbol combination coincides with a defined pattern, such as a scattered pattern.

In one embodiment the symbols are associated with a plurality of reels.

The gaming system may be implemented as a stand alone gaming machine or across a network.

In one embodiment, one or more of the symbol selector and the outcome evaluator is constituted, at least in part, by a processor executing program code stored in a memory.

In one embodiment, the gaming system comprises a game play mechanism operable to place a wager and the outcome evaluator evaluates the outcome based on the wager.

In accordance with a second aspect of the present invention, there is provided a method of gaming comprising the following steps:
selecting a plurality of symbols for display;
displaying the selected symbols;
determining whether the selected symbols correspond with a winning outcome; and
repeatedly successively displaying a symbol associated with the winning outcome and at least one modified representation of the symbol when a winning outcome is determined to exist.

In accordance with a third aspect of the present invention, there is provided a computer program arranged when loaded into a computer to instruct the computer to operate in accordance with a gaming system according to the first aspect of the present invention.

In accordance with a fourth aspect of the present invention, there is provided a computer readable medium having computer readable program code embodied therein for causing a computer to operate in accordance with a gaming system according to the first aspect of the present invention.

In accordance with a fifth aspect of the present invention, there is provided a data signal having computer readable program code embodied therein for causing a computer to operate in accordance with a gaming system according to the first aspect of the present invention.

### BRIEF DESCRIPTION OF SEVERAL VIEWS OF THE DRAWINGS

The present invention will now be described, by way of example only, with reference to the accompanying drawings, in which:

FIG. 1 is a schematic block diagram of core components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network;

FIG. 7a is a diagrammatic representation of a displayed symbol; and

FIGS. 7b to 7e are diagrammatic representations of example modified symbols displayed by a gaming system according to an embodiment of the present invention and associated with the symbol shown in FIG. 7a.

### DETAILED DESCRIPTION OF THE INVENTION

The present gaming system operates such that during game play, a plurality of symbols are randomly selected from a set of symbols and displayed at a corresponding plurality of display positions. The symbols shown at the display positions are used to determine game outcomes by comparing the displayed symbols with defined winning criteria.

For at least some winning outcomes, in order to provide a player with an enhanced winning experience, the winning outcome is communicated to a player by repeatedly successively displaying symbols forming part of the winning outcome and at least one modified representation of each symbol. One or more or all symbols forming part of the winning outcome may be modified in this way.

In the present embodiment, the modified representations of the symbols may be inverse representations, outline representations or representations wherein the colour of a symbol and/or the colour of the symbol background are modified.

Typically, the symbols that form a win line are compared with winning symbol combinations defined in a pay table so as to determine whether a player of the game should receive an award. For example, if winning symbol combinations are based on poker hands, a particular prize would be awarded if the win line comprises four aces. Other winning symbol combinations and corresponding prizes may also be defined by a pay table.

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. In this example, the system is of the type including multiple game modes such as being operable in normal game mode wherein a base game is implemented and special game mode wherein a feature game is implemented.

With some such probabilistic games, the set of symbols used during normal game mode and/or during special game mode include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

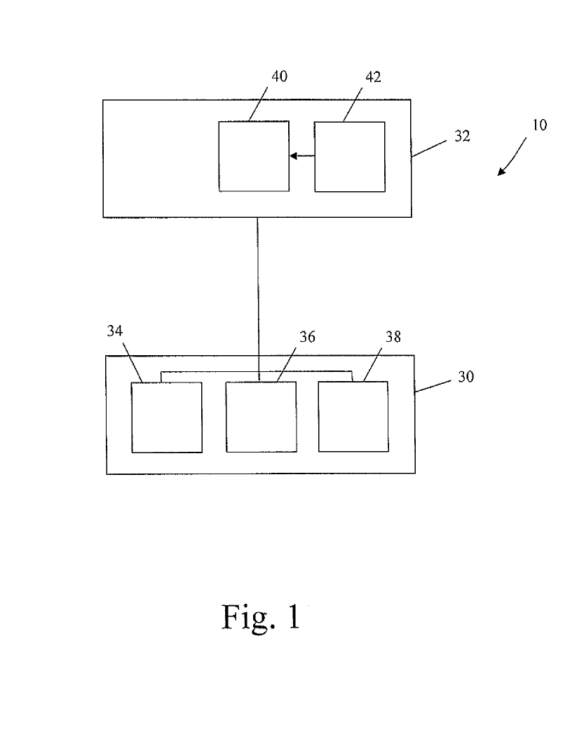

Referring to FIG. 1, a schematic diagram of components of a gaming system 10 in accordance with the present embodiment is shown. The components comprise a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36 which may comprise a touch screen, and a game play mechanism 38 arranged to enable a player to input game play instructions.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

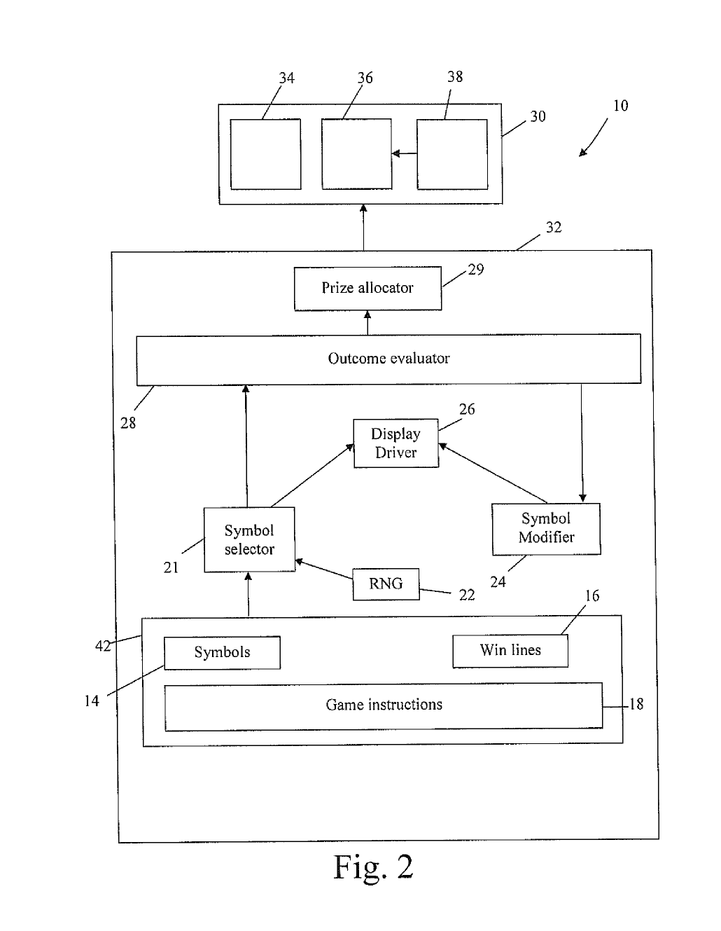

A functional diagram illustrating operative components of the game controller 32 is shown in FIG. 2.

The memory 42 is arranged to store symbols data 14 indicative of a plurality of symbols, win lines data 16 indicative of available win lines, and game instruction data 18 indicative of game instructions usable by the gaming machine 10 to control operation of the game.

The game controller 32 includes a symbol selector 21 which is arranged to select several symbols from the available symbols 14 for display to a player in a plurality of display positions. In this example, the selection carried out by the symbol selector 21 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

The game controller 32 also comprises a symbol modifier 24 and a display driver 26 associated with the display 36.

The game controller 32 also comprises an outcome evaluator 28 which determines game outcomes based on the symbols selected for display to the player and defined win criteria such as defined symbol combinations and defined win lines in accordance with game instructions 18.

If a winning outcome is determined to exist, the outcome evaluator 28 instructs the symbol modifier 24 in association with the display driver 26 to modify the representation of at least one, and in this example all, of the symbols associated with the winning outcome.

The modification is such that the same symbol is displayed but the appearance of the symbol is modified, for example by changing the colour of the symbol and/or the colour of the symbol background; by inverting the symbol, such as by inverting colours of the symbol; by showing the symbol in outline; or by modifying the appearance of the symbol in any other way.

Each symbol forming part of the winning outcome is repeatedly successively displayed with its associated modified symbol so as to provide the appearance of a flashing symbol. In an alternative embodiment, multiple modified representations of a symbol are successively displayed with the symbol.

The game controller 32 also comprises a prize allocator 29 arranged to allocate a prize to a player when a winning outcome exists.

In this example, the gaming system is operable in normal game mode and special game mode.

During normal game mode, a base game is implemented, and during special game mode a feature game is implemented. The feature game may be a modified version of the base game or may be an entirely different game.

In the embodiment described below, the symbol selector 21, the symbol modifier 24, the outcome evaluator 28, and the prize allocator 29 are at least partly implemented using the processor 40 and associated software although it will be understood that other implementations are envisaged.

The gaming system 10 can take a number of different forms.

In a first form, a player operable gaming device in the form of a stand alone gaming machine is provided wherein all or most components required for implementing the game are present in the gaming machine.

In a second form, a distributed architecture is provided wherein some of the components required for implementing the game are present in a player operable gaming device and some of the components required for implementing the game are located remotely relative to the gaming device. For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a device server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

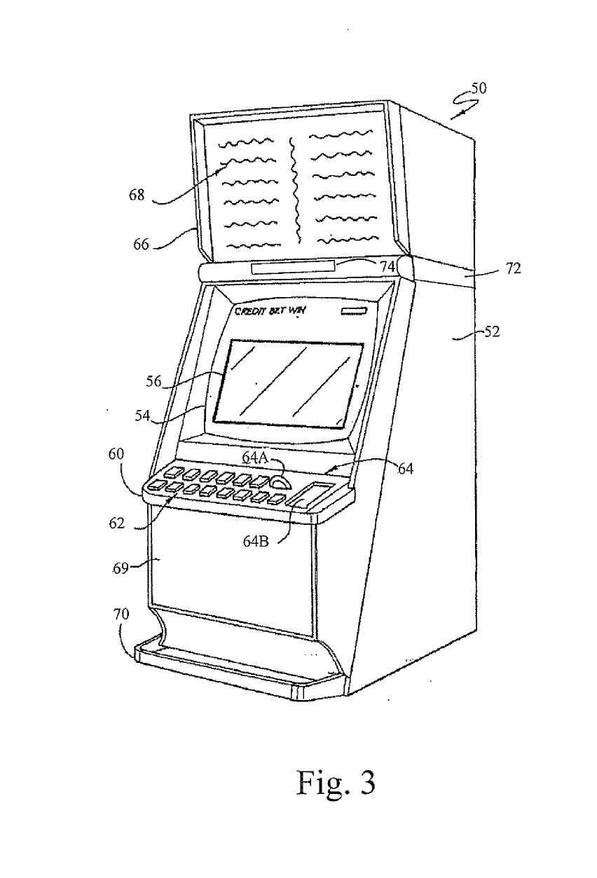

A gaming system in the form of a stand alone gaming machine 50 is illustrated in FIG. 3. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during gameplay. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type. The display 54 may comprise a touch screen usable by a player to interact with the gaming machine, in particular during game play.

The display 54 in this example is arranged to display representations of several reels, each reel of which has several associated symbols. Typically 3, 4 or 5 reels are provided. During operation of the game, the reels first appear to spin then stop with typically three symbols visible on each reel in a display area. Game outcomes are determined on the basis of the symbols visible in the display area after the reels have stopped spinning.

A player marketing module (PMM) 72 having a display 74 is connected to the gaming machine 50. The main purpose of the PMM 72 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

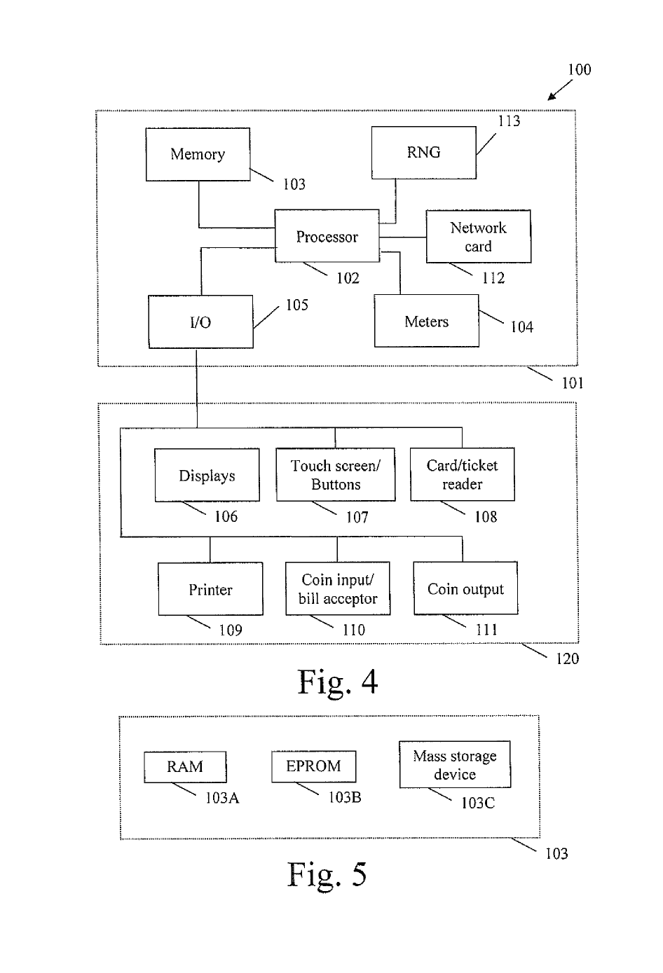

FIG. 4 shows a block diagram of operative components of a gaming device 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

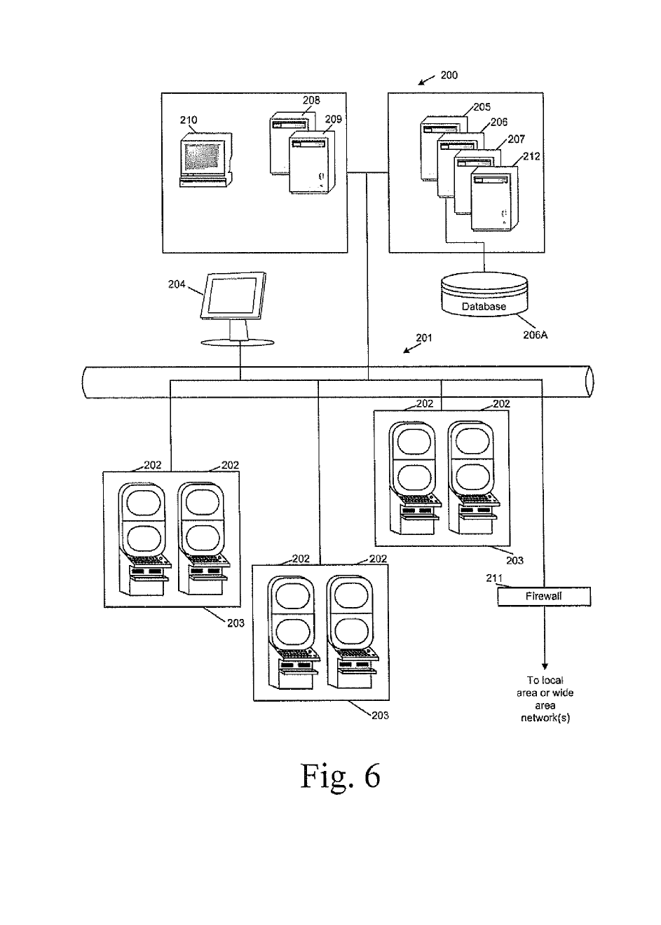

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

Examples of specific implementations of the gaming system will now be described in relation to a stand alone gaming machine 50 although it will be understood that implementation may also be carried out using other gaming system architectures such as a network architecture of the type shown in FIG. 6.

In this example, the gaming system comprises five virtual reels, with each reel having a plurality of associated symbols.

In this example, the gaming system is arranged such that when the reels stop rotating, a plurality of symbols from each reel are displayed in a display area. Win outcomes are determined on the basis of the symbols visible in the display area.

Typically, a player will purchase or otherwise obtain win entitlements such as several win lines which are used in the game to determine win outcomes. If the symbols displayed in the display area include any winning outcomes such as a defined combination of symbols disposed on a win line, the player wins a prize.

When a winning outcome occurs, the symbol modifier 24 causes the appearance of the symbols forming part of the winning outcome to change such that the symbols and alternate representations of the symbols are successively displayed thereby clearly communicating the winning outcome to a player.

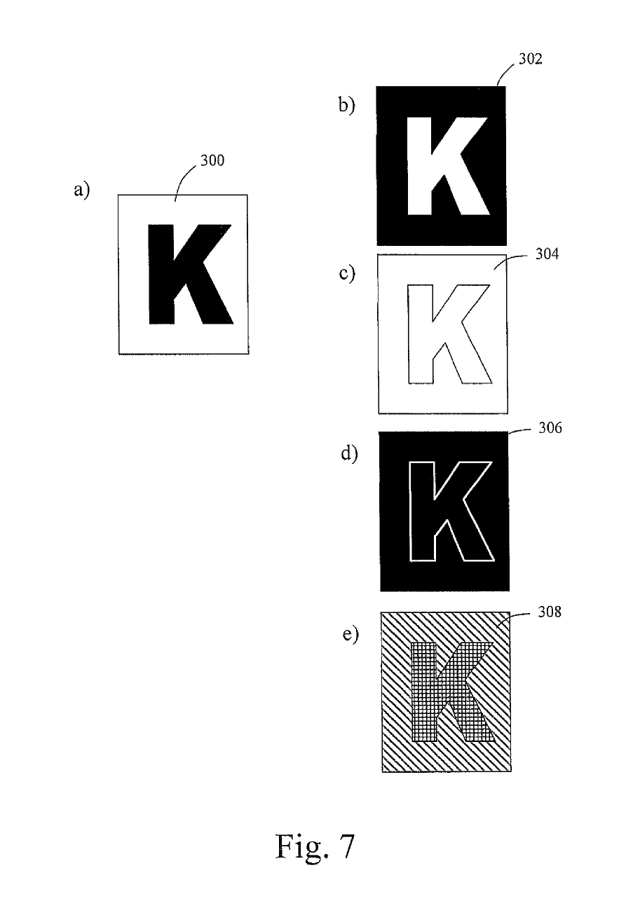

An example symbol 300, in this example a KING symbol, is shown in FIG. 7a. When the symbol 300 forms part of a winning outcome, a modified representation of the symbol 300 is modified shown successively with the symbol. The modified symbol is such that the same symbol is still displayed but its appearance is changed.

For example, as shown in FIG. 7b, the symbol 300 may be modified such that an inverted representation 302 of the symbol is shown. The inverted representation may be an alternate representation of the symbol wherein the colours of the symbol have been inverted.

It will be understood, however, that any suitable modified representation of the symbol is envisaged. For example, the symbol 300 may be modified such that a representation 304, 306 of the symbol in outline is displayed, as shown in FIGS. 7c and 7d, or the symbol 300 may be modified such that the colour of the symbol and/or the colour of a background of the symbol are changed, but the modified colours do not necessarily correspond to inverted colours.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gaming system comprising:
a display;
a symbol selector arranged to select a plurality of symbols for display; and
an outcome evaluator arranged to evaluate the selected symbols to determine whether a winning outcome exists;
the gaming system being arranged to communicate a winning outcome to a player by repeatedly successively displaying a symbol associated with the winning outcome and at least one modified representation of the symbol.

2. A gaming system as claimed in claim 1, wherein the gaming system is arranged to communicate a winning outcome to a player by repeatedly successively displaying a symbol associated with the winning outcome and one modified representation of the symbol.

3. A gaming system as claimed in claim 1, wherein the gaming system is arranged to communicate a winning outcome to a player by repeatedly successively displaying a symbol associated with the winning outcome and a plurality of modified representations of the symbol.

4. A gaming system as claimed in claim 1, wherein the winning outcome is communicated to the player by repeatedly successively displaying all symbols associated with the winning outcome and at least one respective modified representation of each symbol.

5. A gaming system as claimed in claim 1, wherein the modified representation of a symbol is a representation of the symbol wherein the colour of the symbol and/or the colour of a background of the symbol are modified.

6. A gaming system as claimed in claim 5, wherein the modified representation of the symbol is an inverse representation of the symbol.

7. A gaming system as claimed in claim 1, wherein the modified representation of the symbol is an outline representation of the symbol.

8. A gaming system as claimed in claim 1, wherein a winning outcome exists when a defined symbol combination coincides with a defined win line.

9. A gaming system as claimed in claim 1, wherein a winning outcome exists when a defined symbol combination coincides with a defined pattern, such as a scattered pattern.

10. A gaming system as claimed in claim 1, wherein the symbols are associated with a plurality of reels.

11. A gaming system as claimed in claim 1, wherein the gaming system is implemented as a stand alone gaming machine or across a network.

12. A gaming system as claimed in claim 1, wherein one or more of the symbol selector and the outcome evaluator is constituted, at least in part, by a processor executing program code stored in a memory.

13. A gaming system as claimed in claim 1, wherein the gaming system comprises a game play mechanism operable to place a wager and the outcome evaluator evaluates the outcome based on the wager.

14. A method of gaming comprising the following steps:
selecting a plurality of symbols for display;
displaying the selected symbols;
determining whether the selected symbols correspond with a winning outcome; and
repeatedly successively displaying a symbol associated with the winning outcome and at least one modified representation of the symbol when a winning outcome is determined to exist.

15. A method as claimed in claim 14, comprising communicating a winning outcome to a player by repeatedly successively displaying a symbol associated with the winning outcome and one modified representation of the symbol.

16. A method as claimed in claim 14, comprising communicating a winning outcome to a player by repeatedly successively displaying a symbol associated with the winning outcome and a plurality of modified representations of the symbol.

17. A method as claimed in claim 14, comprising communicating the winning outcome to the player by repeatedly successively displaying all symbols associated with the winning outcome and at least one respective modified representation of each symbol.

18. A method as claimed in claim 14, wherein the modified representation of a symbol is a representation of the symbol wherein the colour of the symbol and/or the colour of a background of the symbol are modified.

19. A method as claimed in claim 18, wherein the modified representation of the symbol is an inverse representation of the symbol.

20. A method as claimed in claim 14, wherein the modified representation of the symbol is an outline representation of the symbol.

21. A method as claimed in claim 14, wherein a winning outcome exists when a defined symbol combination coincides with a defined win line.

22. A method as claimed in claim 14, wherein a winning outcome exists when a defined symbol combination coincides with a defined pattern, such as a scattered pattern.

23. A method as claimed in claim 14, comprising associating the symbols with a plurality of reels.

24. A method as claimed in claim 14, comprising constituting one or more of the symbol selector and the outcome evaluator, at least in part, by a processor executing program code stored in a memory.
